(19) United States
(12) Patent Application Publication
(10) Pub. No.: US 2025/0168719 A1
(43) Pub. Date: May 22, 2025

(54) METHOD OF HANDLING NETWORK COEXISTENCE ASSOCIATED WITH REDCAP FEATURE

(71) Applicant: MEDIATEK INC., Hsinchu City (TW)

(72) Inventors: Mu-Chi Fang, Hsinchu City (TW); Tzyuan Shiu, Hsinchu City (TW)

(73) Assignee: MEDIATEK INC., Hsinchu City (TW)

(21) Appl. No.: 18/915,397

(22) Filed: Oct. 15, 2024

Related U.S. Application Data
(60) Provisional application No. 63/601,231, filed on Nov. 21, 2023.

(51) Int. Cl. H04W 36/00; H04W 36/08; H04W 36/30; H04W 36/36

(52) U.S. Cl. CPC H04W 36/0061; H04W 36/08; H04W 36/30; H04W 36/36

(57) ABSTRACT

A communication network system includes a Redcap UE, at least one Redcap base station and at least one regular base station. The Redcap UE currently camping on a Redcap cell covered by a Redcap base station searches for regular neighboring cells covered by a regular base station in the surrounding. The related search information is stored as a database in the Redcap UE, wherein each detected regular neighboring cell is marked as a barred cell and/or the frequency associated with each barred cell is marked as a barred frequency. The Redcap UE performs mobility decisions and interference countermeasures based on the database, thereby improving the success rate and the reliability of handover.

### CROSS REFERENCE TO RELATED APPLICATIONS

This application claims the benefit of U.S. Provisional Application No. 63/601,231, filed on Nov. 21, 2023. The content of the application is incorporated herein by reference.

### BACKGROUND

Wireless communication systems are widely deployed to provide various types of communication content such as voice, video, packet data, messaging, broadcast, and so on. These wireless communication systems may be capable of supporting communication with multiple users by sharing available system resources (e.g., time, frequency, and power). Examples of such multiple-access systems include fourth generation (4G) systems such as long term evolution (LTE) systems, fifth generation (5G) systems which may be referred to as new radio (NR) systems and sixth generation (6G) communication system. These systems may employ technologies such as code division multiple access (CDMA), time division multiple access (TDMA), frequency division multiple access (FDMA), orthogonal frequency division multiple access (OFDMA), or discrete Fourier transform-spread-OFDM (DFT-S-OFDM). A wireless multiple-access communications system may include a number of base stations or network access nodes, each simultaneously supporting communication for multiple communication devices, which may be otherwise known as user equipment (UE).

A wireless communication network may include a base station that can support communication for a UE. The UE may communicate with the base station via downlink and uplink. The downlink refers to a communication link from the base station to the UE, and the uplink refers to a communication link from the UE to the base station.

In 3rd generation partnership project (3GPP) Release 17, a study item “study on support of reduced capability (Redcap) NR devices” has been started to develop. The scope of this study item includes identification and study of potential UE complexity reduction techniques, UE power saving, and battery lifetime enhancements for Redcap UEs. The 3GPP RedCap feature is designed to reduce the complexity of UE in networks, catering to the growing demand for devices with reduced capabilities. By offering a streamlined approach to UE design, the RedCap feature enables the deployment of communication technology in various use cases that require less sophisticated devices. Although Redcap is a 3GPP-defined non-mandatory network feature, a Redcap UE is only able to be connected to a base station which supports Redcap feature.

There may be several coexistence issues when both Redcap base stations and regular base stations are present in the surrounding of a Redcap UE. For example, a Redcap UE currently connected to a Redcap base station may encounter stronger interference from neighboring regular base stations which do not support Redcap feature. Meanwhile, the success rate and the reliability of handover may be downgraded since a Redcap UE is very likely to select a regular base station when performing mobility decisions.

Therefore, there is a need for a method of handling network coexistence associated with Redcap feature.

### SUMMARY

The present invention provides a method of handling network coexistence associated with a Redcap feature. The method includes a Redcap UE currently camping on a first cell covered by a first base station of a first type searching for one or more neighboring cells covered by a base station of a second type; storing related search information as a database in the Redcap UE; the Redcap UE marking each detected neighboring cell covered by any base station of the second type as a barred cell and/or marking a frequency associated with the barred cell as a barred frequency in the database; and the Redcap UE performing a mobility decision based on the database. The first base station of the first type is a Redcap base station configured to cover the first cell which supports the Redcap feature. The base station of the second type is a regular base station configured to cover a regular neighboring cell which does not support the Redcap feature.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a communication network system according to an embodiment of the present invention.

FIG. 2 is a flowchart illustrating a method of handling network coexistence associated with Redcap according to an embodiment of the present invention.

### DETAILED DESCRIPTION

As used herein, the terms “user equipment” and “UE” might in some cases refer to mobile devices such as mobile telephones, personal digital assistants, handheld or laptop computers, and similar devices that have telecommunications capabilities. Such a UE might consist of a device and its associated removable memory module, such as but not limited to a Universal Integrated Circuit Card (UICC) that includes a Subscriber Identity Module (SIM) application, a Universal Subscriber Identity Module (USIM) application, or a Removable User Identity Module (R-UIM) application. Alternatively, such a UE might consist of the device itself without such a module. In other cases, the term “UE” might refer to devices that have similar capabilities but that are not transportable, such as desktop computers, set-top boxes, or network appliances. The term “UE” can also refer to any hardware or software component that can terminate a communication session for a user. Also, the terms “user equipment,” “UE,” “user agent,” “UA,” “user device,” and “mobile device” might be used synonymously herein.

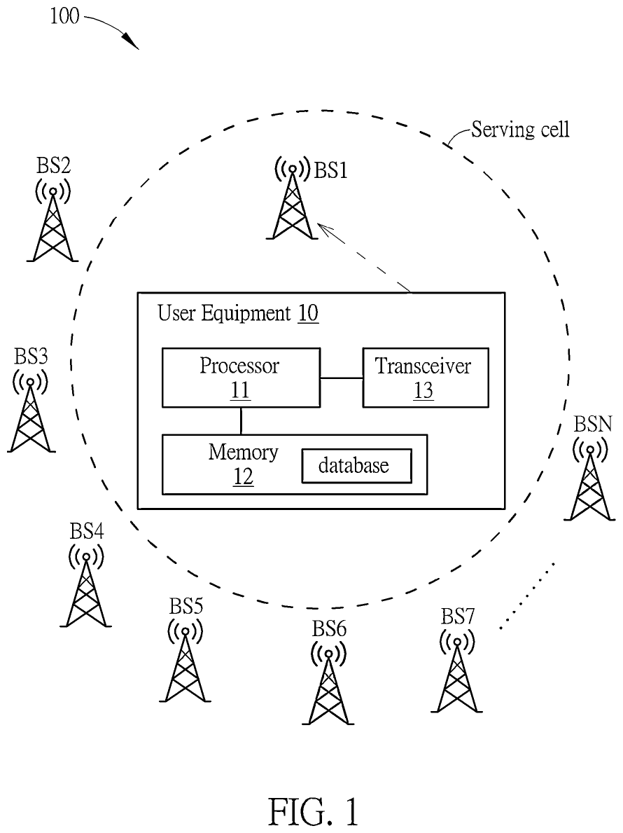

FIG. 1 is a diagram illustrating a communication network system 100 according to an embodiment of the present invention. The communication network system 100 includes user equipment (UE) 10 and a plurality of base stations BS1-BSN, wherein N is an integer larger than 1. The UE 10 may include a memory 12, a transceiver 13, and a processor 11 coupled to the memory 12 and the transceiver 13. The processor 11 may be configured to implement proposed functions, procedures and/or methods described in this description. Layers of radio interface protocol may be implemented in the processor 11. The memory 12 is operatively coupled with the processor 11 for storing a variety of information to operate the processor 11. The transceiver 13 is operatively coupled with the processor 11 and configured to transmit and/or receives a radio signal from a base station. In the present invention, the UE 10 is a Redcap UE which can only be connected to a Redcap base station which supports Redcap feature.

In an embodiment, the processor 11 may include application-specific integrated circuit (ASIC), other chipset, logic circuit and/or data processing device. The memory 12 may include read-only memory (ROM), random access memory (RAM), flash memory, memory card, storage medium and/or other storage device. The transceiver 13 may include baseband circuitry to process radio frequency signals. When the embodiments are implemented in software, the techniques described herein can be implemented with modules (e.g., procedures, functions, and so on) that perform the functions described herein. The modules can be stored in the memory 12 and executed by the processor 11. The memory 12 can be implemented within the processor 11 or external to the processor 11 in which case those can be communicatively coupled to the processor 11 via various means as is known in the art. However, the implementation of the UE 10 does not limit the scope of the present invention.

In the communication network system 100, a cell represents a specific geographical area covered by a base station. Each cell is covered by a base station and receives network services from the base station. The coverage area of each cell is different and may be adjusted according to needs and environment. In an embodiment, the base stations BS1-BSN include at least one base station of a first type and at least one base station of a second type. A base station of the first type is configured to cover a cell of the first type, while a base station of the second type is configured to cover a cell of the second type. In an embodiment of the present invention, a base station of the first type is a Redcap base station configured to cover a Redcap cell which supports Redcap feature, while a base station of the second type is a regular base station configured to cover a regular cell which does not support Redcap feature.

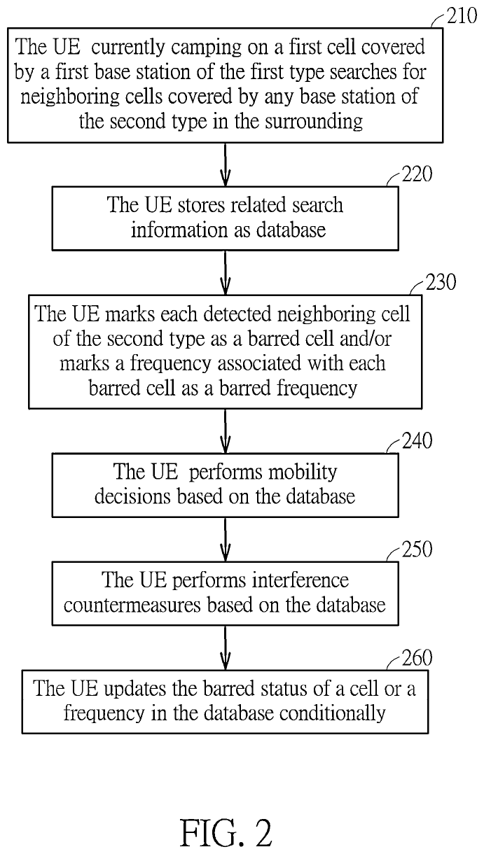

As previously stated, a Redcap UE is only able to camp on a Redcap cell covered by a Redcap base station, and may encounter network coexistence issues when a Redcap base station and a regular base station are both present in the surrounding of the Redcap UE. FIG. 2 is a flowchart illustrating a method of handling network coexistence associated with Redcap according to an embodiment of the present invention. The flowchart in FIG. 2 includes the following steps:

Step 210: the UE 10 currently camping on a first cell covered by a first base station of the first type searches for neighboring cells covered by any base station of the second type in the surrounding.

Step 220: the UE 10 stores related search information as a database.

Step 230: the UE 10 marks each detected neighboring cell covered by any base station of the second type as a barred cell and/or marks a frequency associated with each barred cell as a barred frequency in the database.

Step 240: the UE 10 performs mobility decisions based on the database.

Step 250: the UE 10 performs interference countermeasures based on the database.

Step 260: the UE 10 updates the barred status of a cell or a frequency in the database conditionally.

For illustrative purpose, it is assumed that the Redcap UE 10 is currently camping on the Redcap cell covered by the Redcap base station BS1 (i.e., the serving cell). In step 210, the UE 10 currently camping on the serving Redcap cell covered by the Redcap base station BS1 is configured to search for neighboring regular cells covered by any regular base station in the surrounding.

In an embodiment, the UE 10 may employ two operating mode to search for neighboring regular cells covered by any regular base station in step 210. In the first operating mode, the UE 10 is configured to decode System Information Blocks (SIBs) of all neighboring cells when requested by a spec-defined mobility procedure (such as a camp-on procedure). In the second operating mode, the UE 10 is configured to decode SIBs of all neighboring cells in advance (regardless of whether there is spec-defined mobility procedure happening/to happen). As well-known to those skilled in the art, SIBs are periodically transmitted by all cells for providing essential information to mobile devices within their coverage area. The primary purposes of SIBs include facilitating initial cell selection which helps a UE to choose an appropriate cell to connect to, and cell reselection which allows a UE to switch between cells as needed. SIBs contain general system information, cell identity, cell-specific information, system bandwidth, frequency-related information and neighboring cell information. Among various types of SIBs, SIB1 contains high-level details for cell selection, cell reselection and initial access, such as identity of cell/network operator, supported frequency bands, and system parameters. By decoding the SIB1 broadcasted by neighboring cells, the UE 10 is able to determine if a neighboring regular cell which does not support Redcap feature is present in the area where the UE 10 is present.

In step 220, the UE 10 is configured to store related search information as a database. For example, the UE 10 may store the basic information (such as location, band, frequency, physical cell identity (PCI) and global cell identity), infrastructure, last update time, barred status and signal quality of each detected neighboring cell as a database in its memory 12.

In an embodiment of the present invention, the barred status in the database indicates whether a detected neighboring cell or a frequency is barred during any mobility decision. In step 230, the UE 10 is configured to mark each detected neighboring cell of the second type as a barred cell in the database. In an embodiment, after the UE 10 fails to camp on a specific neighboring cell and then determines that the specific neighboring cell is a regular neighboring cell which does not support Redcap feature as indicated by its SIB1, the UE 10 is configured to mark the specific neighboring cell as a barred cell in the database. In an embodiment, after decoding the SIB1 from a specific neighboring cell and confirming that the specific neighboring cell is a regular neighboring cell which does not support Redcap feature, the UE 10 is configured to mark the specific neighboring cell as a barred cell. In an embodiment, the UE 10 may mark a specific neighboring cell as a barred cell in the database after receiving information or control commands from an application processor (AP)/evolved node B (eNB)/base station (BS) indicating that the specific neighboring cell is a regular cell which does not support Redcap feature or should be barred for some reason. In an embodiment, the UE 10 may mark a specific neighboring cell as a barred cell in the database after referencing to pre-defined information shared by operators or infrastructure vendor indicating that the specific neighboring cell does not support Redcap feature.

In step 230, the UE 10 may also mark the frequency associated with each barred cell as a barred frequency in the database. In an embodiment, if the amount of the barred intra-frequency cells exceeds a predetermined number, the UE 10 may mark the frequency of the barred intra-frequency cells as a barred frequency in the database. In an embodiment, the predetermined number may be 1, 2, 3, 4 or any integer. In another embodiment, the UE 10 may mark a specific frequency as a barred frequency in the database after referencing to pre-defined information shared by operators or infrastructure vendor indicating that the specific frequency does not support Redcap feature in the area where the UE 10 is located.

In step 240, the UE 10 is configured to perform mobility decisions based on the database stored in its memory 12. In an embodiment, the UE 10 is configured to exclude all barred cells and/or barred frequencies in the database from being candidate cells/frequencies to be searched in a cell selection procedure or a cell re-selection procedure, thereby improving the success rate and the reliability of handover.

In another embodiment, after performing a cell selection procedure or a cell re-selection procedure, the UE 10 may determine that a second cell covered by a second base station BS2 is able to provide better signal quality. Before attempting to camp on the second cell immediately, the UE 10 is configured to determine whether the second cell BS2 covered by the second base station BS2 is a barred cell based on the database. The UE 10 is configured to camp on the second cell only after verifying that the second cell with better signal quality is not a barred cell. In other words, the present invention excludes all neighboring cells of the second type (regular cells which do not support Redcap feature) detected in a cell-selection procedure or a cell-reselection procedure from being selected as a target cell for establishing connection even if they can provide better signal quality, thereby improving the success rate and the reliability of handover.

In another embodiment, after performing a cell selection procedure or a cell re-selection procedure, the UE 10 may determine that the second cell covered by the second base station BS2 is able to provide better signal quality. Before attempting to camp on the second cell immediately, the UE 10 is configured to determine whether the frequency of the second cell covered by the second base station BS2 is a barred frequency based on the database. The UE 10 is configured to camp on the second cell only after verifying that the frequency of the second cell with better signal quality is not a barred frequency. In other words, the present invention excludes all neighboring cells each using a barred frequency detected in a cell-selection procedure or a cell-reselection procedure from being selected as a target cell for establishing connection even if they can provide better signal quality, thereby improving the success rate and the reliability of handover.

According to 3GPP spec, the UE 10 is not allowed to camp on a regular neighboring cell which does not support Redcap feature. As a result, any regular neighboring cell may cause strong interferences to the Redcap UE 10. Therefore, the UE 10 is configured to perform interference countermeasures based on the search information stored as the database in step 250.

In an embodiment, after failing to connect to an intra-frequency neighboring cell of the second type (i.e., a regular neighboring cell using the same frequency as the Redcap serving cell), the UE 10 is configured to report A2 event earlier. The A2 event may involve specific measurement conditions, such as the received signal strength (RSSI) or reference signal received power (RSRP) from the serving cell and a neighboring cell. The UE 10 monitors these measurements and reports them to the network when the specified conditions are met. The A2 event allows the network to evaluate the quality and suitability of neighboring cells for potential handover or other network optimization procedures based on the measurements reported by the UE. The A2 event measurements play a role in handover decisions and mobility management, as they provide the network with information about the quality of current serving cell.

In an embodiment, after failing to connect to an intra-frequency neighboring cell of the second type (i.e., a regular neighboring cell using the same frequency as the serving Redcap cell), the UE 10 is configured to take the initiative to search for inter-frequency cells and/inter-RAT cells. If it can be verified that a detected inter-frequency cell or inter-RAT cell supports Redcap feature, the UE 10 is configured to report radio link failure (RLF) earlier in order to break the connection with current Redcap serving cell.

In an embodiment, after failing to connect to an intra-frequency neighboring cell of the second type (i.e., a regular neighboring cell using the same frequency as the Redcap serving cell), the UE 10 (modem part) is configured to inform the application processor (AP) of this situation. The UE 10 is configured to report RLF in order to break the connection with current Redcap serving cell when instructed by the AP.

In an embodiment, after detecting an intra-frequency neighboring cell of the second type (i.e., a regular neighboring cell using the same frequency as the Redcap serving cell), the UE 10 is configured to mark the intra-frequency neighboring cell as a barred cell and/or mark the frequency of the intra-frequency neighboring cell as a barred frequency in the database after encountering RLF. Then, the UE 10 is configured to connect to another frequency or another radio access technology (RAT).

In an embodiment, when determining that there are Redcap neighboring cells and regular neighboring cells interleavedly located in the surrounding, the UE 10 is configured to mark the current frequency of its Redcap serving cell BS1 as a barred frequency in the database after encountering RLF. Then, the UE 10 is configured to connect to another frequency or another RAT.

In step 260, the UE 10 is configured to update the barred status in the database conditionally. In an embodiment, the UE 10 may determine whether the barred status of a specific frequency in the database should be updated based on indicators including UE mobility, time elapse from last update, variation of signal quality of cells on the frequency in the database and/or variation of barred status of cells on the frequency in the database. When the specific frequency in the database is determined to be updated, the UE 10 is configured to decode the SIBs of stronger cells on the specific frequency and then update the barred status of the specific frequency based on the validity and the contents of the decoded SIB in the same manner as previously described.

In another embodiment, the UE 10 may determine whether the barred status of a specific cell in the database should be updated based on indicators including UE mobility, time elapse from last update and variation of signal quality of the specific cell. The UE 10 is configured to update the barred status of the specific cell in the database when the corresponding frequency is determined to be refreshed. When the specific cell in the database is determined to be updated, the UE 10 is configured to decode the SIBs of the specific cell and then update the barred status of the specific cell based on the validity and the contents of the decoded SIB in the same manner as previously described.

In conclusion, in a communication network system when at least one Redcap base station and at least one regular base station are present in the surrounding of a Redcap UE, the Redcap UE currently camping on a Redcap cell covered by a Redcap base station, the Redcap UE is configured to search for regular neighboring cells covered by any regular base station in the surrounding. The related search information is stored as a database in the Redcap UE, wherein each detected regular neighboring cell is marked as a barred cell and/or the frequency associated with each barred cell is marked as a barred frequency. The Redcap UE 10 may then perform mobility decisions and interference countermeasures based on the database, thereby improving the success rate and the reliability of handover.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of handling network coexistence associated with a reduced capability (Redcap) feature, comprising:
a Redcap user equipment (UE) currently camping on a first cell covered by a first base station of a first type searching for one or more neighboring cells covered by a base station of a second type;
storing related search information as a database in the Redcap UE;
the Redcap UE marking each detected neighboring cell covered by any base station of the second type as a barred cell and/or marking a frequency associated with the barred cell as a barred frequency in the database; and
the Redcap UE performing a mobility decision based on the database, wherein:
the first base station of the first type is a Redcap base station configured to cover the first cell which supports the Redcap feature; and
the base station of the second type is a regular base station configured to cover a regular neighboring cell which does not support the Redcap feature.

2. The method of claim 1, further comprising:
the Redcap UE currently camping on the first cell decoding a System Information Block (SIB) of the one or more neighboring cells during a mobility procedure;
the Redcap UE currently camping on the first cell determining whether the one or more neighboring cells covered by any base station of the second type can be detected based on the decoded SIB of each neighboring cell.

3. The method of claim 1, further comprising:
the Redcap UE currently camping on the first cell decoding a System Information Block (SIB) of each neighboring cell in advance of a mobility procedure when the Redcap UE is in an idle mode;
the Redcap UE currently camping on the first cell determining whether the one or more neighboring cells covered by any base station of the second type can be detected based on the decoded SIB of each neighboring cell.

4. The method of claim 1, wherein:
the database contains a location, a band, a frequency, a physical cell identity, a global cell identity, an infrastructure, a last update time, a barred status and a signal quality of each detected neighboring cell; and/or
the database contains at least one of a barred status of the frequency and the location, the band, the physical cell identity, the infrastructure, the last update time, and the barred status of each detected neighboring cell.

5. The method of claim 1, wherein the Redcap UE marking each detected neighboring cell covered by any base station of the second type as the barred cell includes:
the Redcap UE marking a first neighboring cell as the barred cell after failing to camp on the first neighboring cell and then determining that the first neighboring cell does not support the Redcap feature;
the Redcap UE marking a second neighboring cell as the barred cell after decoding a SIB from the second neighboring cell and confirming that the second neighboring cell does not support the Redcap feature;
the Redcap UE marking a third neighboring cell as the barred cell after receiving information or a control command from an application processor (AP) indicating that the third neighboring cell does not support the Redcap feature or should be barred; or
the Redcap UE marking a fourth neighboring cell as the barred cell after referencing to pre-defined information shared by an operator or an infrastructure vendor indicating that the fourth neighboring cell does not support the Redcap feature.

6. The method of claim 1, wherein the Redcap UE marking the frequency associated with each barred cell as the barred frequency includes:
the Redcap UE marking a frequency of barred intra-frequency neighboring cells when an amount of the barred intra-frequency neighboring cells exceeds a predetermined number; or
the Redcap UE marking a specific frequency as a barred frequency after referencing to pre-defined information shared by an operator or an infrastructure vendor indicating that the specific frequency does not support the Redcap feature in an area where the Redcap UE is located.

7. The method of claim 1, wherein the Redcap UE performing the mobility decision based on the database includes:
the Redcap UE excluding all: d cells and/or barred frequencies in the database from being candidate cells/frequencies to be searched when performing a cell selection procedure or a cell re-selection procedure.

8. The method of claim 1, wherein the Redcap UE performing the mobility decision based on the database includes:
the Redcap UE performing a cell selection procedure or a cell re-selection procedure;
after detecting a second cell with a better signal quality than the first cell, the Redcap UE determining whether the second cell is the barred cell based on the database; and
the Redcap UE camping on the second cell after verifying that the second cell with the better signal quality is not the barred cell.

9. The method of claim 1, wherein the Redcap UE performing the mobility decision based on the database includes:
the Redcap UE performing a cell selection procedure or a cell re-selection procedure;
after detecting a second cell with a better signal quality than the first cell, the Redcap UE determining whether a frequency of the second cell is the barred frequency based on the database; and
the Redcap UE camping on the second cell after verifying that the frequency of the second cell with the better signal quality is not the barred frequency.

10. The method of claim 1, further comprising:
the Redcap UE determining whether a barred status of each frequency in the database should be updated based on indicators including a UE mobility, a time elapse from a last update, a variation of signal quality of cells on each frequency in the database and/or a variation of the barred status of each cell on each frequency in the database; and
when a specific frequency in the database is determined to be updated, the Redcap UE decoding a SIB of one or more cells on the specific frequency; and
the Redcap UE updating the barred status of the specific frequency based on a validity and a content of the decoded SIB.

11. The method of claim 10, further comprising:
the Redcap UE updating the barred status of the specific frequency in the database after determining that the specific frequency in the database should be updated; and
the Redcap UE updating the barred status of each cell on the specific frequency in the database.

12. The method of claim 1, further comprising:
the Redcap UE determining whether a barred status of each cell in the database should be updated based on indicators including a UE mobility, a time elapse from a last update and/or a variation of signal quality of each cell; and
when a specific cell in the database is determined to be updated, the Redcap UE decoding a SIB of the specific cell; and
the Redcap UE updating the barred status of the specific cell based on a validity and a content of the decoded SIB.

13. The method of claim 1, further:
the Redcap UE reporting an A2 event earlier after detecting there are intra-frequency neighboring cells covered by any base station of the second type and are causing interference.

14. The method of claim 1, further:
the Redcap UE searching for inter-frequency cells and/inter-RAT cells after detecting there are intra-frequency neighboring cells covered by any base station of the second type and are causing interference;
the Redcap UE searching and measuring cells on inter-frequencies and determining whether a qualified cell exists on the inter-frequencies; and
the Redcap UE reporting a radio link failure (RLF) earlier in order to break a connection with the first cell after determining the qualified cell exists on the inter-frequencies.

15. The method of claim 1, further:
the Redcap UE informing an application processor of a failure to connect to an intra-frequency neighboring covered by any base station of the second type; and
the Redcap UE reporting a radio link failure (RLF) when instructed by the application processor.

16. The method of claim 1, further:
the Redcap UE marking an intra-frequency neighboring cell as the barred cell and/or marking a frequency of the intra-frequency neighboring cell as the barred frequency in the database after encountering an RLF with the intra-frequency neighboring cell; and
the Redcap UE connecting to another frequency or another radio access technology (RAT).

17. The method of claim 1, further:
the Redcap UE marking the first cell as the barred cell and/or marking a frequency of the first cell as the barred frequency in the database after determining that there are Redcap neighboring cells and regular neighboring cells interleavedly located in an area where the Redcap UE is located; and
the Redcap UE connecting to another frequency or another radio access technology (RAT).
